(19) United States
(12) Patent Application Publication
(10) Pub. No.: US 2009/0327501 A1
(43) Pub. Date: Dec. 31, 2009

(54) COMMUNICATION ACCESS CONTROL SYSTEM AND METHOD

(76) Inventors: Athellina Athsani, San Jose, CA (US); Elizabeth F. Churchill, San Francisco, CA (US); Ronald Martinez, San Francisco, CA (US)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 12/163,101

(22) Filed: Jun. 27, 2008

(51) Int. Cl. G06F 15/16

(52) U.S. Cl. 709/229

(57) ABSTRACT

Disclosed herein are one or more systems and methods to control communication access to a user via one or more communication clients, each of which provides a mode of communication, to communicate with a user, using communication access control items and communication access control conditions associated with each of the communication clients.

### FIELD OF THE DISCLOSURE

The present disclosure relates to controlling communication, and more particularly to control communication clients, each of which provides a mode of communication, to communicate with a user based communication access control conditions associated with the communication clients.

### BACKGROUND

It is not atypical for a user to have many different manners of communication using a number of different devices to communicate with others. For example, a user may have both a mobile line and a land line for voice and/or data communications. The user may have multiple alternatives for accessing the Internet. In addition, the user may have the ability to communicate with others via voice, electronic mail, social network messaging clients such as twitter and facebook, really simple syndication (RSS), text messaging, etc. communication alternatives. The user could have a preference for one over the other at various times.

### SUMMARY

It would be beneficial to be able to control communication access alternatives, so that the user can control how others communicate with the user, and vice versa, based on user preferences. The present disclosure seeks to address failings in the art and to provide methods and systems to control and manage communication associated with multiple communication modes available to the user.

Disclosed herein are one or more systems and methods to control communication access to a user via one or more communication clients, each of which provides a mode of communication, to communicate with a user, using communication access control items and communication access control conditions associated with each of the communication clients.

In accordance with one or more embodiments, a system is provided that comprises one or more computing devices, or processors, configured to provide communication access control functionality in accordance with such embodiments. In accordance with one or more embodiments, communication access control functionality is embodied in steps of a method performed by at least one computing device, or processor. In accordance with one or more embodiments, program code to implement communication access control functionality in accordance with one or more such embodiments is embodied in, by and/or on a computer-readable medium, or on a machine-readable medium.

In accordance with one or more embodiments, a system is provided to control communication access. The system comprises at least one processor configured to provide a communication access control component coupled to a communication client via a communication network. The communication access control component is configured to identify at least one condition of a communication access control item that is to be used to control access to a user via the communication client, the at least one condition to be used to identify an action to be taken in response to a communication access request directed to the user via the communication client, identify at least one item of information associated with the communication access request, and identify the action to be taken in response to the communication access request using the at least one item of information and the at least one condition of the communication access control item.

In accordance with one or more embodiments, a communication access control method is provided, such that at least one condition of a communication access control item that is to be used to control access to a user via a communication client is identified. The at least one condition is to be used to identify an action to be taken in response to a communication access request directed to the user via the communication client. At least one item of information associated with the communication access request is identified, and the action to be taken in response to the communication access request is identified using the at least one item of information and the at least one condition of the communication access control item.

In accordance with one or more embodiments, a computer-readable medium comprises program code to control communication access. The program code comprises code to identify at least one condition of a communication access control item that is to be used to control access to a user via a communication client. The at least one condition is to be used to identify an action to be taken in response to a communication access request directed to the user via the communication client. The program code further comprises code to identify at least one item of information associated with the communication access request, and the action to be taken in response to the communication access request using the at least one item of information and the at least one condition of the communication access control item.

In accordance with one or more embodiments, a user interface is provided that comprises a geographic information input area to input geographic information for a communication access control item that is to be used to control access to a user via a communication client, the geographic information to be used with a geographic-based condition to identify an action to be taken in response to a communication access request directed to the user via the communication client.

In accordance with one or more embodiments, the geographic information and geographic-based condition are to be used to determine whether or not to grant the communication access request directed to the user based on a current location of the user relative to the geographic information, based on the current location of an originator of the communication access request relative to the geographic information, or both. In accordance with one or more embodiments, the geographic information comprises a geographic location, a geographic boundary, or both. In accordance with one or more embodiments, the geographic information input area can comprise a text field, a map display area, or both a text field and a map display area. In accordance with one or more embodiments, the user interface comprises a windowing element that comprises at least one input field to be used to input and/or view information associated with the communication access control item, and the windowing element can be superimposed on the map display area of the user interface. In accordance with one or more embodiments, a map display area of the user interface displays one or more icons, each icon corresponding to a communication access control item and being displayed at a location in the map display area corresponding to geographic information input for the communication access control item. In accordance with one or more embodiments, the user interface comprises a display area that displays one or more groups of communication access control items.

### DRAWINGS

The above-mentioned features and objects of the present disclosure will become more apparent with reference to the following description taken in conjunction with the accompanying drawings wherein like reference numerals denote like elements and in which:

FIG. 1, which includes FIGS. 1A and 1B, provides examples of registration and communication management for use in accordance with one or more embodiments of the present disclosure.

FIG. 2, which includes FIGS. 2A and 2B, provides communication access control item examples and examples of associated information for use in controlling communication access in accordance with one or more embodiments.

FIG. 3 provides an example of components for use in accordance with one or more embodiments of the present disclosure.

FIG. 4 provides an example of a network that includes multiple instances of the communication access component in accordance with one or more embodiments of the present disclosure.

FIG. 5 provides an example of a hierarchy of communication access control items for use in accordance with one or more embodiments of the present disclosure.

FIG. 6, which comprises FIGS. 6A to 6E, provides examples of a graphical user interface for use in accordance with one or more embodiments of the present disclosure.

FIG. 7 illustrates some components that can be used in connection with one or more embodiments of the present disclosure.

### DETAILED DESCRIPTION

In general, the present disclosure includes a communication access control system, method and architecture.

Certain embodiments of the present disclosure will now be discussed with reference to the aforementioned figures, wherein like reference numerals refer to like components.

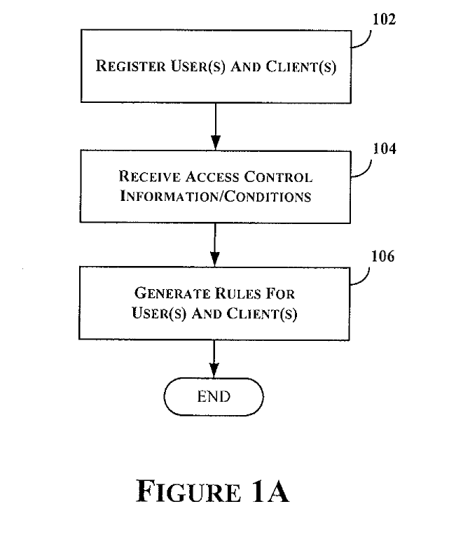

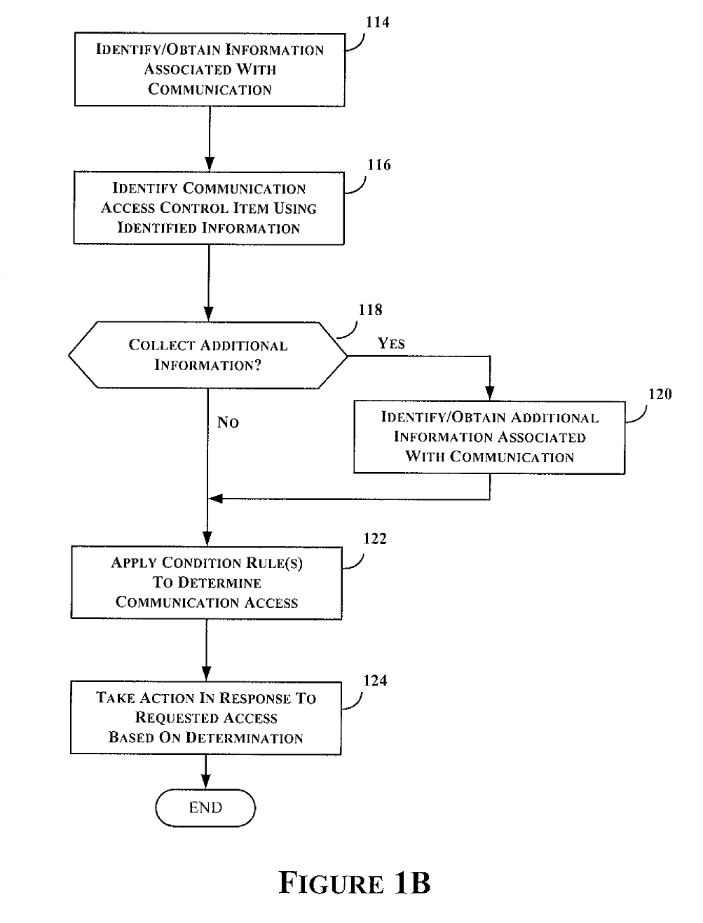

FIG. 1, which includes FIGS. 1A and 1B, provides examples of registration and communication management for use in accordance with one or more embodiments of the present disclosure. In accordance with one or more embodiments, users can register one or more clients, which can include devices, such as without limitation a cell phone, personal computer, handheld audio/video player, personal data assistant (PDA), beeper, pager, global positioning satellite (OPS), or other device by which users can communicate. A client can be software, such as without limitation an electronic mail, instant messaging, text messaging, voice mail, etc. that configures a device to provide functionality. By way of a non-limiting example, a handheld device can provide electronic mail capability via an electronic mail client that executes on the handheld device.

At step 102 of FIG. 1A, one or more users register with the system. By way of a non-limiting example, during registration, a user provides personal information, such as without limitation the user's name, address, username, password, employer, telephone number(s), as well as information about one or more of the user's clients, one or more social networks, affiliations, social groups, etc. In addition to explicit information provided by the user, in accordance with one or more embodiments, implicit information can be collected for the user. By way of a non-limiting example, information about a contact of the user can be obtained via one or more Internet searches. Other information that can be collected, either through explicit or implicit input, includes without limitation one or more contacts and/or communication conditions. The contacts can include without limitation names, addresses (e.g., street, e-mail, instant messaging, etc.), etc. of one or more acquaintances of the user. An acquaintance can be other users, persons, as well as business, etc.

At step 104, input is received from a registered user to identify one or more communication access control items for use in controlling communication access for the user. By way of a non-limiting example, a communication access control item can have associated information to identify a duration, contacts, location and conditions. Duration information associated with a communication access control item can be used to specify a schedule, e.g., a period of time in which the communication access control item is valid. Contacts information associated with a communication access control item can be used to identify one or more persons, entities, etc. for which the communication access control item is to be used. Location information can correspond to a geographic location, such as without limitation a GPS location, location of a cellular tower, area code, country code, etc., that can be used to control communication access. Condition information can comprise one or more conditions that can be used together with information about a communication to determine what, if any, action is to be taken. By way of some non-limiting action examples, a determination can be made to grant, deny, delay, reroute, relay, forward, etc. communication using information associated with the communication. By way of another non-limiting example, a frequency with which communications are forwarded to the user can be specified for a given communication access control item, e.g., one or more held messages can stored and then forwarded to the user in accordance with a frequency.

In accordance with one or more embodiments, the user, the originator of the communication access request, or both can be notified of the action taken by the system. By way of some non-limiting examples, the notification can be provided immediately, or it can be delayed. In accordance with one or more embodiments, the notification can be made using a mode of communication other than the mode of communication of the communication access request. In accordance with one or more embodiments, the notification can be made to the originator that the request is denied and can include one or more suggestions of alternative modes of communication that can be used to communicate with the user via another communication access request, an alternate timing for the communication access request, etc.

At step 106, rules, or other filtering mechanism, corresponding to at least one communication access control item associated with the user and one or more of the user's clients are generated. In accordance with one or more embodiments, one or more rules can be used to implement conditions associated with a communication access control item. By way of some non-limiting examples, a rule can be established in connection with a communication access control item to allow the user to restrict communication access to the user based on the user's geographic location and/or one or more other users' geographic locations, based on an affiliation, etc. In one exemplary scenario, a user, John, wants to insure that he receives any communication coming from Hospital A while his mother is in intensive care in the hospital. In this scenario, John can create a communication access control item, which results in one or more rules being generated that are to be used to determine whether or not to grant access via one or more modes of communication registered for John, e.g. cell phone, land phone, PDA, text message, e-mail, etc. Using the system, John can specify that any form of communications coming from Hospital A should have the highest level of communication access priority. For example, if John gets a communication access request from work and Hospital A at the same time, Hospital A's request will be presented first.

In another exemplary scenario, John has a friend who is visiting Korea. Whether or not he knows the country code or area codes for Korea, John can set a communication access control item, and one or more conditions, to alert him to calls coming from Korea during the period of his friend's visit. In addition to the location condition, John can input information regarding a duration for the communication access control item, the times of day/night during which access is to be permitted with respect to one or more modes of communication, etc. In this scenario, one or more rules can be generated using implicit information, e.g., information collected about the country code and area codes in Korea, as well is explicit, e.g., conditions provided by John as to the duration of his friend's visit to Korea, the times of day during which John wishes to receive calls from his friend, instructions from John to direct any telephone call from his friend that originates from Korea to one or more of John's registered clients, e.g. cell phone, land phone, voicemail, etc.

As yet another exemplary scenario, John can create a communication access control item to address his desire that his coworkers be able to contact him via his instant messaging client when he is in proximity to her workplace, and not otherwise. One or more rules can be established that use geographic-based information, e.g., GPS information, as to John's location and the location of John's workplace/coworkers, as well as other information, e.g., contact information that identifies John's coworkers, to determine whether or not an instant message originates from one of John's coworkers, and to determine whether or not to accept the message based on whether or not John is “at work.”

In accordance with at least one embodiment, in response to receiving a communication, one or more communication access control items can be identified, and one or more rules associated with the identified communication access control item(s) are consulted together with information about the communication to determine the action(s) to be taken in response to a communication.

Referring to FIG. 1B, at step 114, in response to a communication, information associated with the communication is identified. At step 116, one or more communication access control items are identified using the information collected at step 114. At step 118, a determination is made whether or not additional information is to be collected. In accordance with one or more embodiments, the determination can be made based on the information collected at step 114, information associated with the communication access control item identified at step 116, or both. By way of a non-limiting example, a condition associated with an identified communication access control item may require location information for the communication originator, the user, or both the originator in the user. In such a case and if this information was not collected at step 114, a determination can be made at step 118 that additional information is to be collected. If it is determined at step 118 that additional information is to be collected, processing continues at step 120 to collect the additional information. Processing then continues at step 122. If it is determined, at step 118, but no additional information is to be collected, processing continues at step 122.

At step 122, rules that are to be used to determine an action, or actions, to be taken with respect to the communication are identified and then applied to determine whether or not permit the requested access. At step 124, one or more actions is taken in accordance with the determinations made at step 122 and a communication access control item(s) identified at step 116. By way of a non-limiting example, access in the form of a phone call made to a user's landline phone can be denied, e.g. the caller can be sent to the user's voicemail, the caller can receive a busy signal although the user is not currently using the landline phone, etc. In a case that the response is to route the caller to the user's voicemail, the communication access control item can specify a particular voice mail client, e.g., voicemail client for the user's landline or mobile line. By way of yet another non-limiting example, a voicemail message sent to the user's voicemail client can be forwarded as an e-mail to the user's e-mail client. The voicemail, or the e-mail being, can be sent in accordance with frequency information associated with the communication access control item.

In accordance with one or more embodiments of the present disclosure, information associated with a communication can include geographic, or location, information associated with the communication. By way of a non-limiting example, the geographic information can be associated with the originator of the communication, with the recipient of the communication, or both. Geographic information can be determined from, for example and without limitation, information obtained from a global positioning system (GPS). Information obtained from the communication itself, from the origination and/or recipient client, e.g., cellular tower location, and the like.

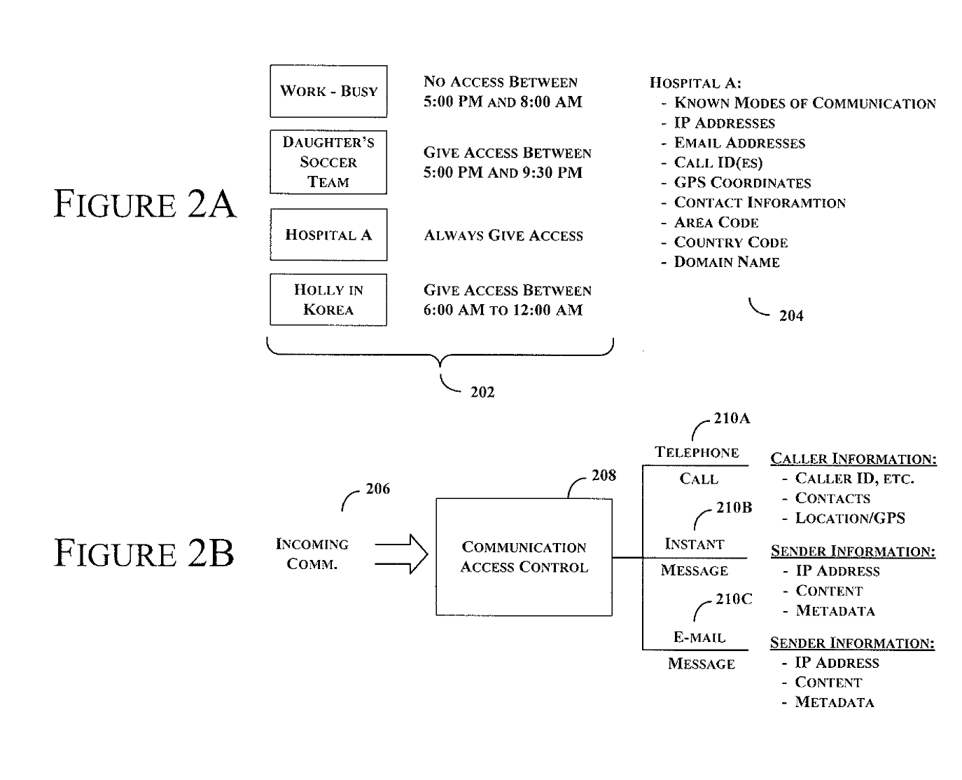

FIG. 2, which includes FIGS. 2A and 2B, provides communication access control item examples and examples of associated information for use in controlling communication access in accordance with one or more embodiments. In the example shown in FIG. 2A, items 202 for handling communications from the user's work contacts, daughter's soccer team, persons associated with Hospital A, and a friend vacationing in Korea. The Work—Busy item 202 indicates that no communication access from the user's work contacts is to be granted after 5 p.m. or before 8 a.m., and that daughter's soccer team members, parents, officials, etc. are not to be given access to the user during work hours, e.g., 8 a.m. to 5 p.m. The Hospital A item can be used with the example described above, in which the user's mother is to be admitted to the hospital's ICU for a period of time. The Hospital A control item can give anyone connected to Hospital A access to the user via any mode of communication and at any time of the day. The Holly in Korea control item can be used so that the user can receive communications from the user's friend who is visiting Korea. In addition to the country code and area code information, the user can refine the condition associated with be control item so that the friend is given access to the user when the friend calls between 6 a.m. and 12 a.m.

Element 204 provides examples of information that can be retained and/or used in connection with the Hospital A control item. The information can be used to determine whether or not any incoming communication originates from someone associated with Hospital A. By way of a non-limiting example, the known modes of communication information can be used to identify whether the incoming communication is a mode that would be used by someone at Hospital A. By way of another non-limiting example, the IP addresses and e-mail addresses can be used to identify that an instant message or an e-mail message originates from someone associated with Hospital A. Other non-limiting examples include caller ID, GPS coordinates, contact information (e.g. address book information), area code, domain names, and the like. Some or all of the information 204 can be obtained from the user explicitly, and/or obtained implicitly, e.g. via collection operations such as without limitation Internet searches, retrieval operations to retrieve information from existing data stores (e.g., contact/address book, calendar, etc. data stores) and the like.

Referring to FIG. 2B, an incoming communication 206, and/or information about incoming communication 206, is received by communication access control component 208. If the incoming communication 206 is determined to be a telephone call 210A, the communication access control component 208 can review such information as caller information, e.g., caller ID, area code, country code, contact information, location information (e.g., CPS information), so as to identify the caller. In the case of control items 202, for example, the caller identification information can be used to determine whether or not one of control items 202 applies. If the caller is a work contact, a member of the user's daughter's soccer team, for example, the Work—Busy or Daughter's Soccer Team control items can be used, together with the current time, to determine whether or not to give the caller access to the user. If the caller is determined to be someone associated with Hospital A, the Hospital A control item can be used to give the caller access to the user without regard to the time of the call. If the caller information identifies an area code or country code associated with Korea, the Holly in Korea condition, together with the current time, can be used to determine whether or not to give the caller access to the user.

In accordance with one or more embodiments, control items 202 can identify an access for one mode of communication, or for more than one mode of communication. For example, in addition to a telephonic mode of communication, the Holly in Korea control item can be used for various messaging modes of communication, which can have different conditions then the telephonic mode of communication, such that if the incoming communication 206 is an instant message 210B or an e-mail 210C, the Holly in Korea control item can specify that Holly is to be given access to the user via either type of message regardless of the time, since such type of communication mode is likely not to be as interruptive as a telephone call.

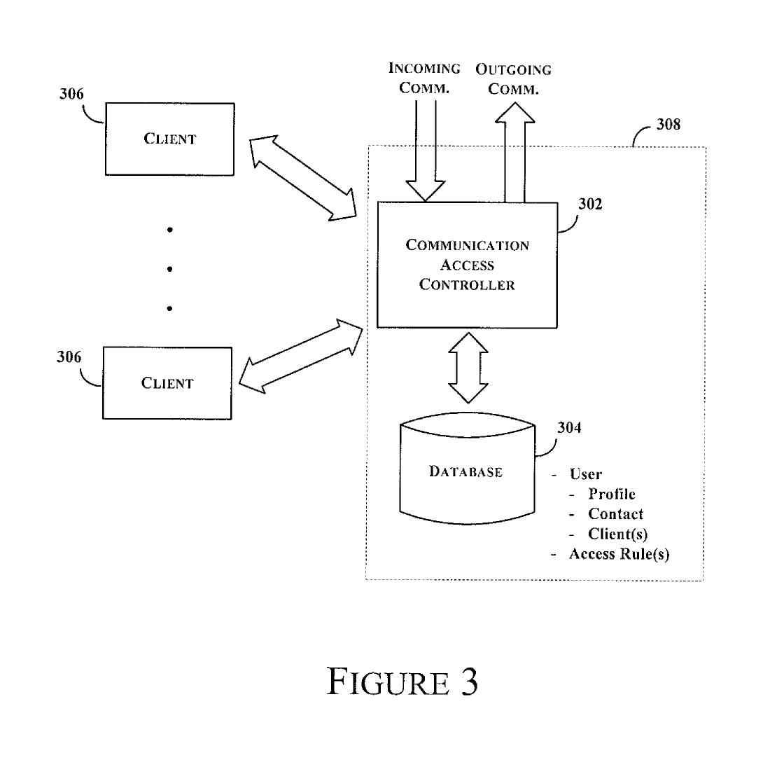

FIG. 3 provides an example of components for use in accordance with one or more embodiments of the present disclosure. Component 308, which corresponds to component 208 of FIG. 2A, comprises communication access controller 302, which is coupled to database 304. Database 304 stores user information, which can include without limitation user profile information, user contacts, and information about the user's client(s), as well as one or more access rules. Information stored in the database 304 identified the one or more clients 306 of a user. Client 306 can comprise hardware, software, or some combination of hardware and software. Examples of hardware include, without limitation, a device such as a cellular telephone, smart phone, public-switched telephone, a computing device, etc. Examples of software clients include without limitation, voice mail, electronic mail, social network messaging clients such as twitter and facebook, really simple syndication (RSS), text messaging, etc. The hardware and software examples provided herein are not intended to be limiting. It should be apparent that embodiments of the present disclosure can be used with any hardware and/or software clients now known or later developed. Communication access controller 302 can be used to manage incoming communication, e.g., communication directed to the user, as well as outgoing communication, e.g. communication originated by the user. By way of a non-limiting example, a user's outgoing communication from the client 306 can be directed based on one or more rules established for the user, and/or one or more rules established for the user to which the outgoing communication is directed.

In accordance with one or more embodiments, communication access controller 302 can be one or more computing devices, such as without limitation a server, personal computer, smart phone, or other computing device. Database 304 can be a database management system, or some other type of data store. Database 304 can be local to the communication access controller 302, or it can be remote. In addition and without limitation, database 304 can comprise more than one instance of database 304. Similarly, communication access controller 302 can comprise one or more instances of communication access controller 302.

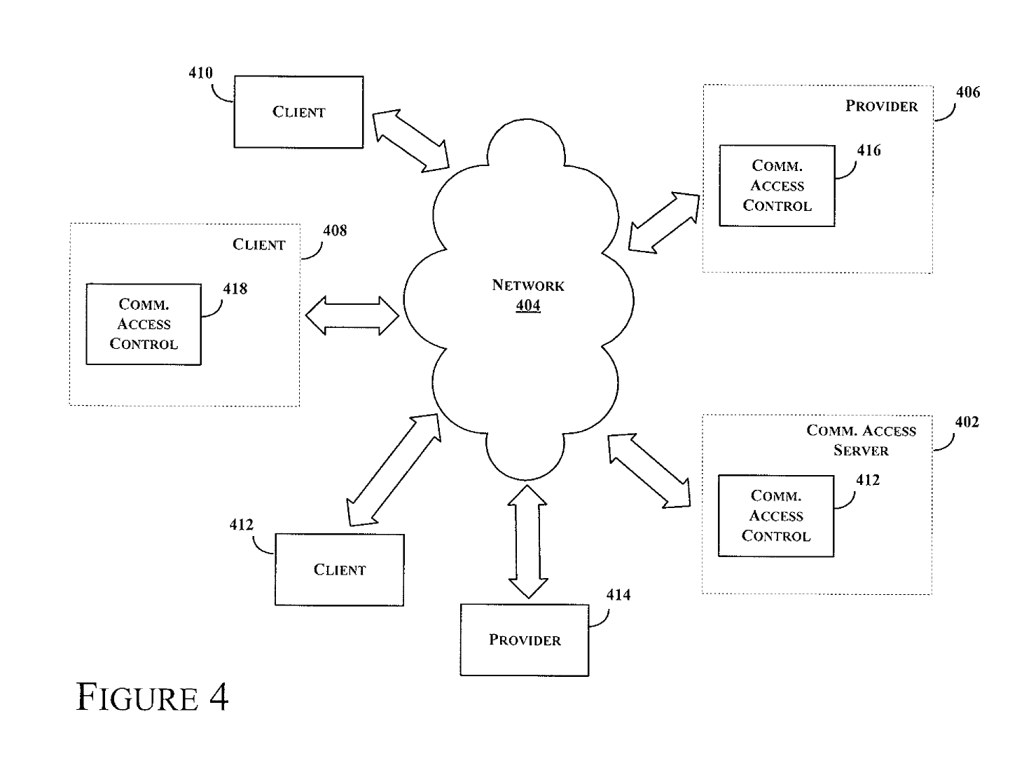

In accordance with one or more embodiments, there can any number instances of component 308, any one of which can be local to a client 306, local to a provider for client 306, or centralized for use with multiple clients 306 and providers. FIG. 4 provides an example of a network that includes multiple instances of the communication access component in accordance with one or more embodiments of the present disclosure.

In accordance with one or more embodiments, the communication access control component 308 of FIG. 3 can be internal to a client, a component of a provider that provides a service to a client, and/or a stand-alone component that provides a service to one or more clients and/or providers. By way of the non-limiting example, client 408 includes communication access control component 418, which can be used either alone or in combination with another communication access control component 308 to control access via client 408. By way of another non-limiting example, provider 406 can include a communication access control component, e.g., communication access control component 416, which can be used to control access to one or more of clients 408, 410 and 412. Provider 406 can be, for example and without limitation, a cellular, Internet, instant messaging, text messaging, etc., provider. By way of yet another non-limiting example, the communication access control component 308 can be any component that is separate from a clients and/or a provider, such as communication access server 402, which includes communication access control component 412. Examples of network 404 include without limitation, one or more of the Internet, a cellular network comprising a network of cell towers, a public switched telephone network, etc. alone or in some combination.

In accordance with one or more embodiments, communication access control component 412 and 416 can comprise one or more servers. In accordance with one or more embodiments, communication access control component 418 can communicate with communication access control component 412 and/or 416 to control communication access for client 408. By way of a non-limiting example, communication access control component 418 can retrieve information from communication access control component 412 and/or 416 including without limitation conditions, rules, identification information, etc.

In accordance with one or more embodiments, control items can be grouped and control items in a group can relate to each other in a master-retainer model, such that a retainer control item can derive, or inherit, information from a master control item in the group, e.g., a retainer control item can inherit conditions, duration, contacts, location information associated with a master control item in the group hierarchy. In accordance with one or more such embodiments, the user can assign a “master” control item and set content preferences for the master control item. In accordance with one or more such embodiments, the user can create multiple instances of master-retainer groups. In accordance with one or more embodiments, communication access priority levels can be set, e.g., either dynamically or manually, based on the master-retainer hierarchy defined for a group. By way of a further non-limiting example, communication access control group hierarchies can be created and/or edited, either manually or automatically, to enable communication access control priorities. By way of yet another non-limiting example, communication access control groups and/or group hierarchies can be matched with contextual information surrounding the user, people in the user's social network and current conditions. As yet another non-limiting example, aggregated behavior and routine patterns can be used to set a condition or a group of conditions and/or used to make automated suggestions regarding one or more conditions and/or condition groups.

Groups can be selected for the user automatically, e.g., by a communication access control component through user behavior and/or routine profiling, or selected manually by the user based on the user's preferences. Embodiments of the present disclosure allow each group to derive information from each other and serve up information relevant to each other. By way of a non-limiting example, a communication access focus can be created for a collection of groups or several communication access focuses can be created each for a different group collections based on user preferences and/or settings. In accordance with one or more embodiments, a communication access focus within the group can be created using hierarchical relationships, e.g., using a master-retainer model, between the groups, such that each group has a master group that passes on information for that group to one or more retainer groups that are children of the master group.

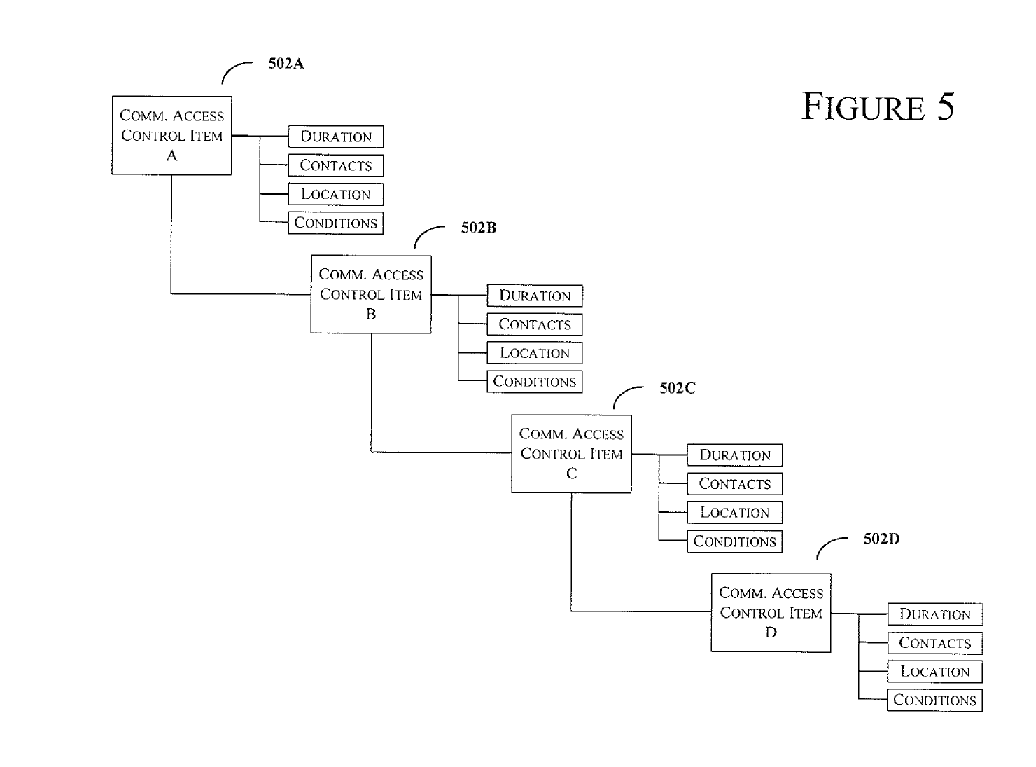

FIG. 5 provides an example of a communication access control item group and hierarchy for use in accordance with one or more embodiments of the present disclosure. In the example shown in FIG. 5, a control item group comprises control items 502A to 502E. Hierarchical relationships can be established for the control items in the group. In the example shown in FIG. 5, control item 502A is a master with control items 502B to 502D as its retainer items, and control item 502B is a master with control items 502C and 502D as its retainer items. Each of control items 502 can have information, such as, without limitation, duration, contacts, location and/or conditions, by virtue of an inheritance of information from a master control item, information input for the control item, or both. Conflicts between master and retainer information can be resolved in favor of the master or the retainer, depending on a configuration.

By way of a non-limiting example and with reference to the Hospital A example discussed above, John can balance his commitment to care for his mother with his other commitments, such as his commitments at work and commitment to coaching his daughter's soccer team. John's mother is expected to be in the hospital from August 8 to September 8, and John wants to make sure any method of communication coming from Hospital A's ICU has the highest level priority during his mother's hospital stay. This can include communications such as telephone calls, e-mail messages, short message service (SMS) messages from his relatives who are within the vicinity of the hospital (e.g., location information can be determined using cell phone tower proximity, GPS information, etc.), as well as telephone calls from hospital personnel associated with the hospital. A communication access control item group can be defined, Mother in Hospital, which comprises Hospital A as the master control item, with retainer groups Work—Busy and Daughter's Soccer Team, so that while his mother is in the hospital one or more communication access control components can monitor communications and take action in accordance with the grouping of the Hospital A, Work—Busy and Daughter's Soccer Team communication access control items and the relationships between the control items in the group. By way of some non-limiting examples, Mother in Hospital group specified that any communications concerning his mother's stay in the hospital are to be granted access regardless of the time of day, communications concerning his daughter's soccer team are to be filtered so that only communications between 5 p.m. and 9:30 p.m. are to be given access, and communications from work are to be filtered so that access is limited before 8 a.m. and after 5 p.m. By grouping the Work—Busy, Daughter's Soccer Team, and Hospital A control items, John can establish a shared duration, e.g., the month that his mother is in the hospital, for all of the communication access control items in the group, and coordinate the filters for each one of the items in the group, for example. By way of a further non-limiting example, if there is a shared contact between control items in the Mother in Hospital group, e.g. a doctor who works at Hospital A has a daughter who is a member of John's daughter's soccer team, a call from the doctor at 2:00 p.m. can be handled using the Hospital A control item rather than the Daughler's Soccer Team control item, so that the doctor's call can be routed to John. By way of yet a further non-limiting example, the doctor's location might be used to determine a possible subject of the call, so that the call can be handled using the Daughter's Soccer Team control item instead of the Hospital A control item if the doctor's location is that a soccer complex.

Continuing with the Mother in Hospital example, information associated with the Hospital A control item can be automatically derived, such as the hospital contacts (e.g., collection of default phone numbers for the hospital's ICU, GPS location, doctors' and nurses' public contact information such as business phone/fax/cell phone numbers, instant messages, myspace blogs, facebook/twitter statuses etc.) with any other information that John wishes the system to use to filter communication access. For the communication access control conditions, John sets the status to always accept all modes, or forms, of communication from contacts associated with the Hospital A control item for the duration specified for the control item. The Hospital A control item is set as the master control item in a Mother In Hospital group of control items, so that the Hospital A control item, and communication controls associated with the Hospital A control item, can always supersede the other control items in the group.

By way of a non-limiting example, in accordance with one or more embodiments, a user can input information to create/edit a control item, and/or a control item group, via a user interface displayed in a browser window at the user's computer in response to a webpage definition received by the user's computer from a website available on the Internet. The information input by the user is received at a server associated with the website, which stores appropriate information in one or more data stores, e.g. one or more databases. As discussed above, other information associated with one or more control items, and/or control item groups, can be collected and stored. The stored data can be used by one or more communication access control components to control access to the user. In a case that a control item, and/or control item group, has a duration, or schedule, the duration information can be used to determine whether or not the control item, and/or control item grouping, is valid. In a case that a control item, and/or control item group, has associated frequency of occurrence information for one or more modes of communication, the frequency information can be used to determine whether one or more communications are to be forwarded to the user, and/or when the communications are to be forwarded to the user. By way of a non-limiting example, frequency of occurrence of communications can be used to determine a level of priority of the communications, and/or can be used to determine whether or not to grant or deny the communication access requests. By way of a further non-limiting example, in a case that the system detects a number of communications from a given originator, e.g., using the same or different modes of communication, the system may set the priority to a higher, or lower, priority. If the priority is set higher, the higher-priority communication(s) can be forwarded to the user immediately and/or the user can be notified of the communication(s). In accordance with one or more embodiments, the system can notify the user using any one or more of the modes of communications available to the user. In addition, the notification can comprise a visual, audible, or both visual and audible, notification.

In accordance with one or more embodiments, the system can maintain expressed, or explicit, information, such as without limitation one or more default settings and/or settings provided by the user, such as without limitation whether or not the system can take action automatically, e.g., without seeking the user's prior approval. In accordance with one or more embodiments, the system can be configured to collect and maintain implicit information, such as without limitation information about user behavior and circumstances associated with the behavior, to take action and/or make recommendations to the user regarding one or more actions to be taken. In accordance with one or more embodiments, the system can collect implicit information, e.g., track a user's behavior in connection with one or more communications, identify information associated with the user's action and/or the communication, and use the information collected by the system to predict the user's future behavior(s) and/or notify the user and/or prompt the user with one or more recommendations in connection with a communication. In addition and if so configured, e.g., based on user preference or other configuration information, the system can use the information collected by the system to take action without the need for user intervention.

In accordance with one or more embodiments, one or more implicit conditions can be used to determine whether or not to grant a communication access request, and/or what type of communication access to use to communicate with the user. In some cases, an implicit condition can take on a higher priority than an explicit condition, such that the implicit condition overrides the explicit condition. Alternatively, an explicit condition can override any implicit condition. By way of a non-limiting example, a geographic location of the user, such as a public library, can be used to determine that certain modes of communication, such as telephonic communications, are not available to the user during the time that the user is in the geographic location. The system can use the user's geographic location, which can be determined any number of ways including GPS information, to deny telephone communication access requests, and/or divert a telephonic access request to a different mode of communication, such as a messaging mode of communication. By way of yet another non-limiting example, a user's electronic calendar can be used to identify times during the day that the user is unavailable for all or certain modes, or types, of communication access request, e.g., communication access requests are limited based on a calendar entry indicating the user's attendance at a departmental meeting.

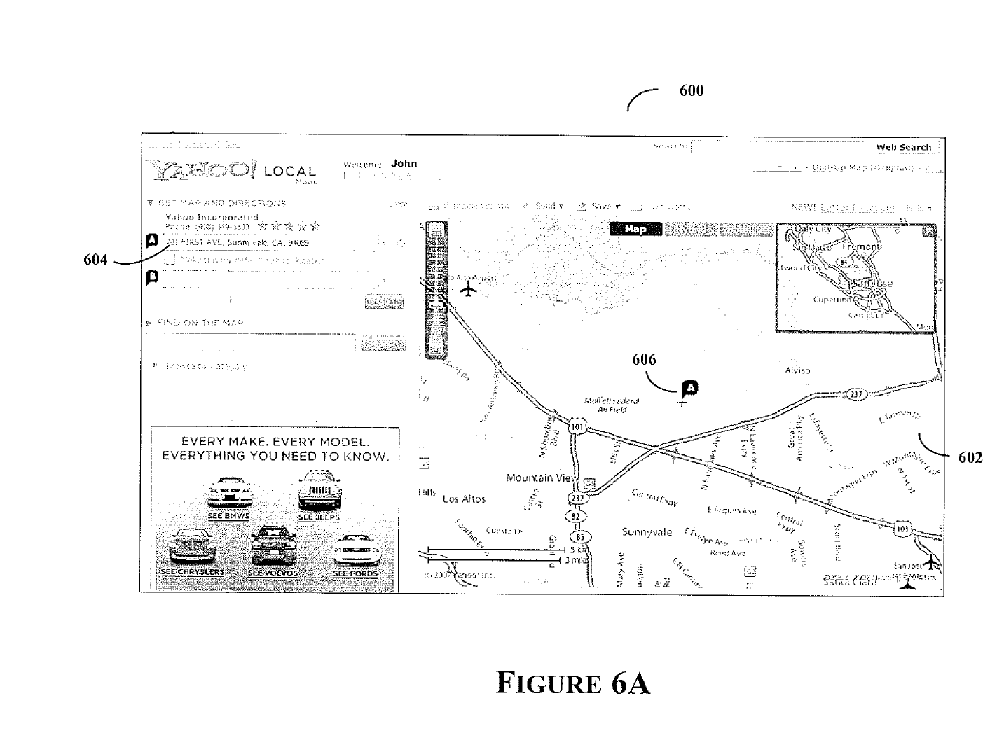

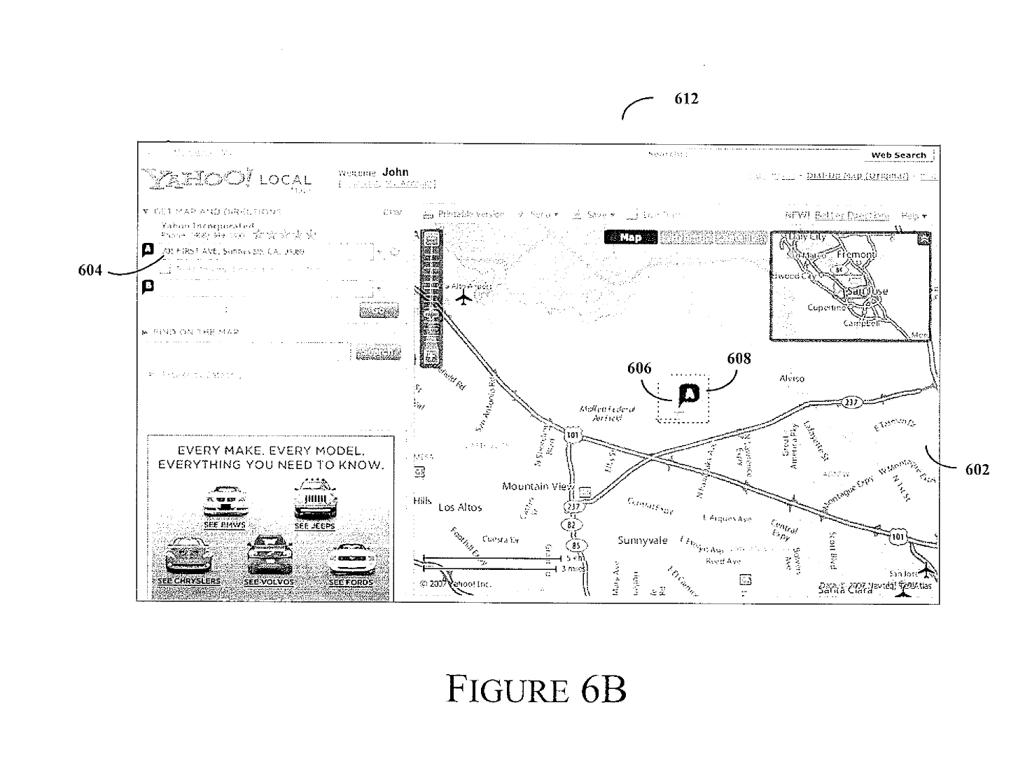

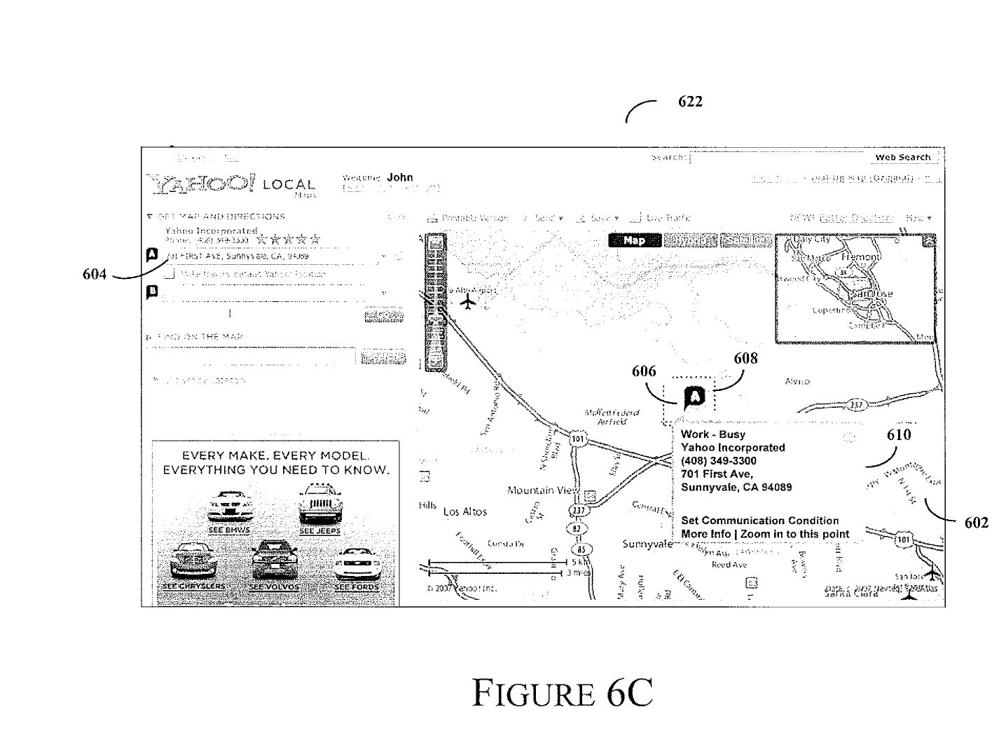

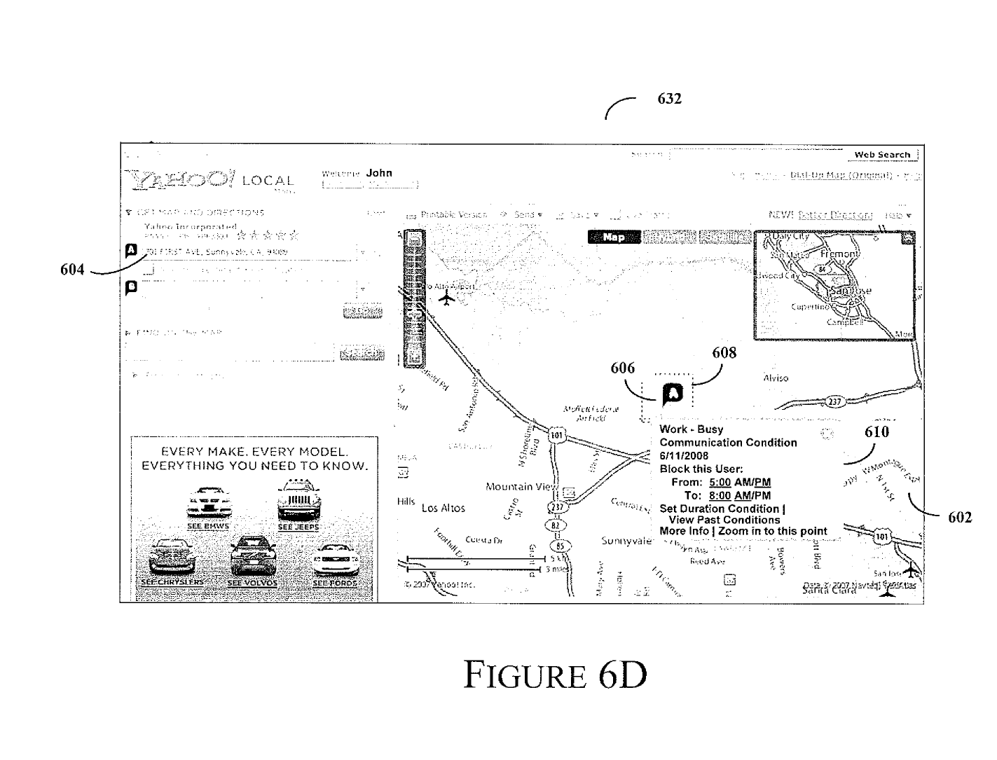

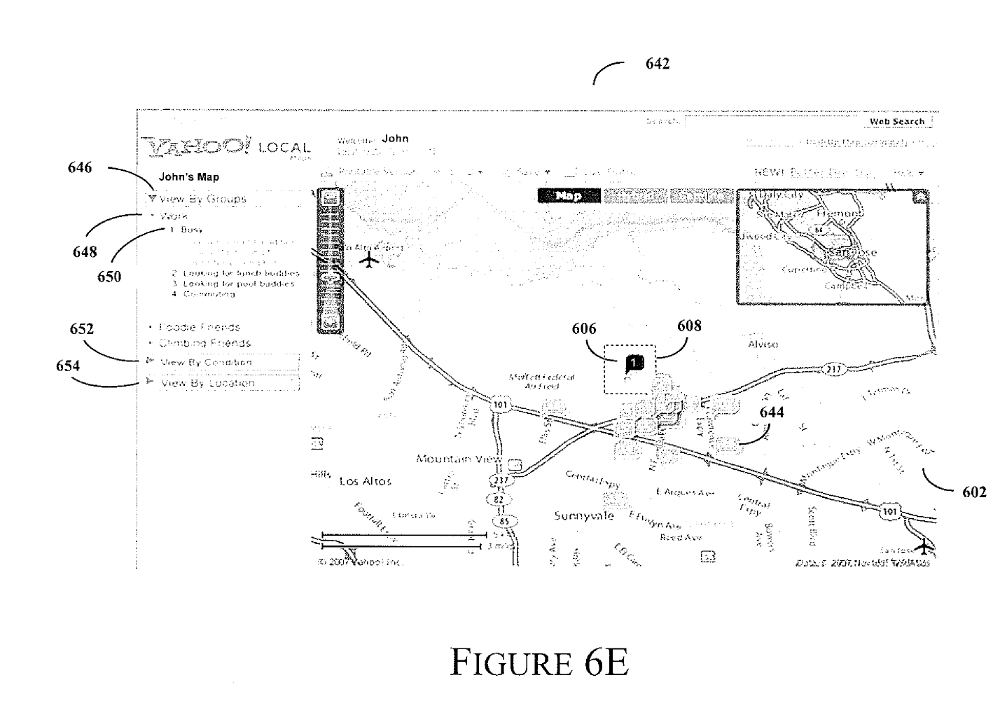

FIG. 6, which comprises FIGS. 6A to 6E, provides examples of a graphical user interface for use in accordance with one or more embodiments of the present disclosure. In accordance with one or more embodiments, a map-like user interface is provided which allows the user to specify information, such as, without limitation, a geographic location, and/or geographic boundary, associated with a communication access control item, and/or control item group. Referring to FIG. 6A, web page 600 comprises an input field 604 that can be used by the user to specify a geographic location by address. The geographic location 606 associated with the address input using input field 604 can be shown in map display 602 Alternatively, field 604 can be used as an output field to display an address of a location 606 selected by the user using map display 602.

Referring to FIG. 6B, web page 612 includes an indicator 608 of a boundary for the control item. The boundary can be automatically determined, e.g., based on configuration information that identifies a boundary size to be used around a geographic location, with the boundary size and/or geographic location being automatically identified or specified by the user, for example. Alternatively, the boundary can be drawn by the user using a map display area and one or more input devices, e.g., a pointing device such as a mouse, cursor controls of a keyboard, etc. Referring to FIG. 6C, element 610 can be used to specify and/or review information associated with the control item. In accordance with one or more embodiments, the element 610 is superimposed over an area of the user interface, e.g., over map display area 602. By way of some non-limiting examples, element 610 can include input and/or output fields to identify a label, or name, of the control item (e.g., Work—Busy), address, telephone number, etc. In addition and in accordance with one or more embodiments, element 610 can include options to provide additional information for the control item, such as, without limitation, one or more communication conditions, and/or to request additional information about the control item, via the More Info and/or the Zoom in to this point selection(s).

Referring to FIG. 6D, web page 632 includes elements 610, which displays the name of the control item, as well as communication condition fields, which can be used to specify and/or review condition information for the control item. In addition and accordance with one or more embodiments, element 610 can include options to set a duration condition for the control item, view past conditions for the control item, request additional information about the control item and/or zoom into the location in the map display 602.

In accordance with one or more embodiments and with reference to FIG. 6E, web page 642 comprises an area 640 two view control items by group, condition, location, etc. in the example shown in FIG. 6E, a view can be expanded and collapsed. By way of a non-limiting example, a view 646 of control item groups is expanded to show Work, Foodie Friends and Climbing Friends groups. The Work control item group is expanded to show control items within the Work group, e.g., Busy, Looking for lunch buddies, Looking for pool buddies, and Commuting control items. The Work—Busy control item is expanded, so that the user can make a selection listed under the control item, e.g., View Current Conditions, View Past Condition, Add New Condition, etc. to view and/or modify information associated with the selected control item.

In accordance with one or more embodiments, map display 602 can display icons 606 and 644, each of which is associated with a control item. By selecting one of the icons, the user can access the control item. In the example shown in FIG. 6E, the user selected an icon associated with the Work—Busy control item. In response, the system changed the display of the icon to icon 606, to indicate the selection, and expanded the viewing hierarchy in area 640 to display the Work—Busy control item.

In accordance with one or more embodiments, the system can track a user's routine patterns, and create/edit/delete groups and or group hierarchies based on the user's routine patterns detected by the system. The system can alert the user of the new group and/or group hierarchies when the user engages the user interface. The user can use the user interface shown in FIG. 6 to verify and/or edit the group, group hierarchies, control items within the group as necessary.

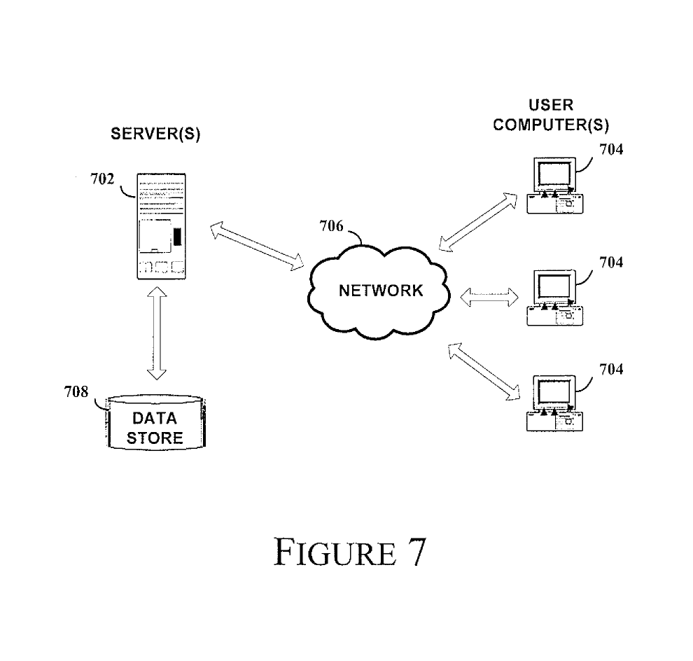

FIG. 7 illustrates some components that can be used in connection with one or more embodiments of the present disclosure. In accordance with one or more embodiments of the present disclosure, one or more computing devices, e.g., one or more servers, user devices or other computing device, 702 are configured to comprise functionality described herein. For example, a computing device 702 can be configured to provide communication access control component 208 and/or 302, and/or to provide a user interface, such as that shown in FIG. 6 or other user interface, to allow the user to create, edit, and/or view communication access control items/groups, etc., and/or to allow the user to register with the system, in accordance with one or more embodiments of the present disclosure. The same or another computing device 702 can be associated with one or more resource data store 708, which can correspond to database 304. It should be apparent that one or more computing devices 702 can be used to provide one or more communication access control components 208/302.

Computing device 702 can serve content to user computers 704 using a browser application via a network 706. Network 706 can correspond with network 404, for example. Data store 708 can be used to store contact information, and/or other information that can be collected by a communication access control component 208.

The user computer 704 can be any computing device, including without limitation a personal computer, personal digital assistant (PDA), wireless device, cell phone, internet appliance, media player, home theater system, and media center, or the like. For the purposes of this disclosure a computing device includes a processor and memory for storing and executing program code, data and software, and may be provided with an operating system that allows the execution of software applications in order to manipulate data. A computing device such as server 702 and the user computer 704 can include one or more processors, memory, a removable media reader, network interface, display and interface, and one or more input devices, e.g., keyboard, keypad, mouse, etc. and input device interface, for example. One skilled in the art will recognize that server 702 and user computer 704 may be configured in many different ways and implemented using many different combinations of hardware, software, or firmware.

In accordance with one or more embodiments, a computing device 702 can make a user interface, such as without limitation the user interface shown in FIG. 6, available to a user computer 704 via the network 706. In accordance with one or more embodiments, computing device 702 can make a user interface available to a user computer 704 by communicating a definition of the user interface to the user computer 704 via the network 706. The user interface definition can be specified using any of a number of languages, including without limitation a markup language such as Hypertext Markup Language, scripts, applets and the like. The user interface definition can be processed by an application executing on the user computer 704, such as a browser application, to output the user interface on a display coupled, e.g., a display directly or indirectly connected, to the user computer 704.

In at least one embodiment, the network 706 can be the Internet, an intranet (a private version of the Internet), or any other type of network. An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

It should be apparent that embodiments of the present disclosure can be implemented in a client-server environment such as that shown in FIG. 7. Alternatively, embodiments of the present disclosure can be implemented other environments, e.g., a peer-to-peer environment as one non-limiting example.

For the purposes of this disclosure a computer readable medium stores computer data, which data can include computer program code executable by a computer, in machine readable form. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A system for controlling communication access comprising:
at least one processor configured to provide a communication access control component coupled to a communication client via a communication network, the communication access control component configured to:
identify at least one condition of a communication access control item that is to be used to control access to a user via the communication client, the at least one condition to be used to identify an action to be taken in response to a communication access request;
identifying at least one item of information associated with the communication access request;
identifying the action to be taken in response to the communication access request using the at least one item of information and the at least one condition of the communication access control item.

2. The system of claim 1, wherein the at least one condition is a geographic-based condition, the at least one item of information comprises geographic information, and the action to be taken is based on the geographic-based condition and the geographic information.

3. The system of claim 1, wherein the at least one condition is a geographic-based condition, the at least one item of information comprises geographic information, and the action to be taken is based on a current location of the user relative to the geographic information.

4. The system of claim 1, wherein the at least one condition is a geographic-based condition, the at least one item of information comprises geographic information, and the action to be taken is based on a current location of an originator of the communication access request relative to the geographic information.

5. The system of claim 1, wherein the at least one condition is a geographic-based condition, the at least one item of information comprises geographic information, and the action to be taken is based on current locations of the user and the originator of the communication access request relative to the geographic information.

6. The system of claim 1, wherein the communication client comprises a hardware client.

7. The system of claim 6, wherein the hardware client comprises the communication access control component.

8. The system of claim 1, wherein the communication client comprises a software client.

9. The system of claim 1, wherein the communication client comprises a combination of hardware and software.

10. The system of claim 1, wherein the communication access control component comprises a server computer coupled to the communication client via the communication network.

11. The system of claim 1, wherein a computing device is configured to provide the communication client coupled to the communication access control component.

12. The system of claim 1, wherein the action comprises routing the communication to communication client.

13. The system of claim 1, wherein the communication access request is made to a first communication client comprises a first communication client, and the action comprises redirecting the communication access request directed to the first communication access client to another communication client.

14. The system of claim 1, wherein the action comprises denying the communication access request.

15. The system of claim 1, wherein the action comprises delaying the communication access request for a determined period of time.

16. The system of claim 15, wherein the communication access request is made to a messaging communication client, and the action comprises delaying the communication access request in accordance with frequency information associated with the communication access control item for the messaging communication client.

17. The system of claim 1, wherein the communication access control item is a member of a group of communication access control items, the communication access control item being a master to one or more other communication access control items in the group, each of the other communication access control items being a retainer to the master such that at least some of the information associated with the master is inherited by the retainer.

18. A method for controlling communication access, comprising:
identifying at least one condition of a communication access control item that is to be used to control access to a user via a communication client, the at least one condition to be used to identify an action to be taken in response to a communication access request directed to the user via the communication client;
identifying at least one item of information associated with the communication access request;
identifying the action to be taken in response to the communication access request using the at least one item of information and the at least one condition of the communication access control item.

19. The method of claim 18, wherein the at least one condition is a geographic-based condition, the at least one item of information comprises geographic information, and the action to be taken is based on the geographic-based condition and the geographic information.

20. The method of claim 18, wherein the at least one condition is a geographic-based condition, the at least one item of information comprises geographic information, and the action to be taken is based on a current location of the user relative to the geographic information.

21. The method of claim 18, wherein the at least one condition is a geographic-based condition, the at least one item of information comprises geographic information, and the action to be taken is based on a current location a current location of an originator of the communication access request relative to the geographic information.

22. The method of claim 18, wherein the at least one condition is a geographic-based condition, the at least one item of information comprises geographic information, and the action to be taken is based on current locations of the user and the originator of the communication access request relative to the geographic information.

23. The method of claim 18, wherein the communication client comprises a first communication client, and the action comprises redirecting the communication access request directed to the first communication client to another communication client.

24. The method of claim 18, wherein the communication access control item is a member of a group of communication access control items, the communication access control item being a master to one or more other communication access control items in the group, each of the other communication access control items being a retainer to the master such that at least some of the information associated with the master is inherited by the retainer.

25. A computer-readable medium embodying program code for controlling communication access, the program code comprising code to:
identify at least one condition of a communication access control item that is to be used to control access to a user via a communication client, the at least one condition to be used to identify an action to be taken in response to a communication access request directed to the user via the communication client;
identify at least one item of information associated with the communication access request;
identify the action to be taken in response to the communication access request using the at least one item of information and the at least one condition of the communication access control item.

26. The medium of claim 25, wherein the at least one condition is a geographic-based condition, the at least one item of information comprises geographic information, and the action to be taken is based on the geographic-based condition and the geographic information.

27. The medium of claim 25, wherein the at least one condition is a geographic-based condition, the at least one item of information comprises geographic information, and the action to be taken is based on a current location of the user relative to the geographic information.

28. The medium of claim 25, wherein the at least one condition is a geographic-based condition, the at least one item of information comprises geographic information, and the action to be taken is based on a current location a current location of an originator of the communication access request relative to the geographic information.

29. The medium of claim 25, wherein the at least one condition is a geographic-based condition, the at least one item of information comprises geographic information, and the action to be taken is based on current locations of the user and the originator of the communication access request relative to the geographic information.

30. The medium of claim 25, wherein the communication access control item is a member of a group of communication access control items, the communication access control item being a master to one or more other communication access control items in the group, each of the other communication access control items being a retainer to the master such that at least some of the information associated with the master is inherited by the retainer.

31. A user interface comprising:
a geographic information input area to input geographic information for a communication access control item that is to be used to control access to a user via a communication client, the geographic information to be used with a geographic-based condition to identify an action to be taken in response to a communication access request directed to the user via the communication client.

32. The user interface of claim 31, wherein the geographic information comprises a geographic location.

33. The user interface of claim 31, wherein the geographic information comprises a geographic boundary.

34. The user interface of claim 31, wherein the geographic information input area comprises a text field.

35. The user interface of claim 31, wherein the geographic information input area comprises a map display area.

36. The user interface of claim 31, wherein the geographic information input area comprises a text field and a map display area.

37. The user interface of claim 31, the user interface comprises a windowing element that comprises at least one input field to be used to input and view information associated with the communication access control item.

38. The user interface of claim 31, the user interface comprises a map display area and the windowing element is superimposed over the map display area of the user interface.

39. The user interface of claim 31, the user interface comprises a map display area that displays one or more icons, each icon corresponding to a communication access control item and being displayed at a location in the map display area corresponding to geographic information input for the communication access control item.

40. The user interface of claim 31, the user interface comprises a display area that displays one or more groups of communication access control items.
